(19) United States
(12) Patent Application Publication
(10) Pub. No.: US 2014/0144797 A1
(43) Pub. Date: May 29, 2014

(54) Paintbrush Holder

(71) Applicant: Lash Laniakea Lareau, Mililani, HI (US)

(72) Inventor: Lash Laniakea Lareau, Mililani, HI (US)

(21) Appl. No.: 13/507,544

(22) Filed: Nov. 29, 2012

(51) Int. Cl. B44D 3/12

(52) U.S. Cl. CPC B44D 3/123
USPC 206/361

(57) ABSTRACT

Paintbrush Holder can be hook onto the side of a paint can, allowing the paint to be easily accessed at all times. This unique product can comprise a plastic holder that can resemble and fit over a paintbrush head. The holder can have two aluminum hooks for attaching the paintbrush the paint can. The holder can also have a magnet to secure the paintbrush to the holder. At the bottom of the holder can be a slit for easy washing and draining of the paintbrush holder. The holder can be offered in three different sizes to accommodate different-sized paintbrushes. Each size can correspond with the colors orange, yellow, green. The exact specifications, materials used, and method of use of paintbrush holder may vary upon manufacturing.

### BRIEF DESCRIPTION

Paintbrush Holder can be used to hook paintbrushes directly onto a can of paint for quick access and easy storage.

### PURPOSE OF THE INVENTION

Paintbrush Holder can provide painters with a convenient way to store their paintbrush for easy access. This innovative product can resemble a holder that can be shaped like the head of a paintbrush and can have two hooks on the back to allow painters to hook the holder onto a paint can. By using this product, painters don't have to prop up their brush on a stool or the ladder, where the brush can get in the way and easily get knocked off. Professional painters, contractors, and at-home do-it-yourselfers can all appreciate the convenience and practicality afforded by this product.

### PROBLEMS SOLVED BY THE INVENTION

When painting, painters have a very limited number of places they can set their brushes down. Some painters may prop their brush on the ladder or a side table, but the brushes can easily get knocked off. Other painters may prop their brush up on the side of the pan. The brush can accidently fall into the pan, however, getting paint all over the handle. If stored anywhere else, painters won't be able to easily access their brush when needed. An effective solution to prevent these problems is necessary.

### DETAILED DESCRIPTION

Paintbrush Holder can be hooked onto the side of a paint can, allowing the paintbrush to be easily accessed at all times. This unique product can comprise a plastic holder that can resemble and fit over a paintbrush head. The holder can have two aluminum hooks for attaching the paintbrush to the paint can. The holder can also have a magnet to secure the paintbrush to the holder. At the bottom of the holder can be a slit for the easy washing and draining o f the paintbrush holder. The holder can be offered in three different sizes to _accoIT11119 date different-sized paintbrushes. Each size can correspond with the colors orange, yellow, and green. The exact specifications, materials used. And method of use of Paintbrush Holder may vary upon manufacturing.

### SPECIFICATIONS

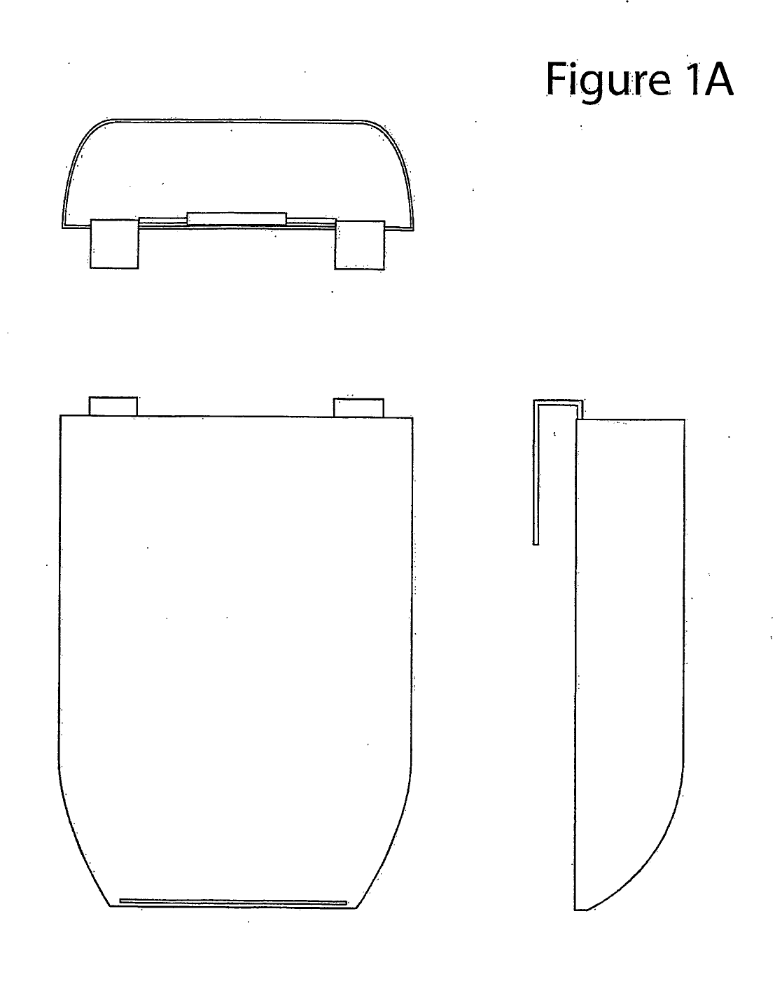

FIG. 1A Front view, Side view, Top view

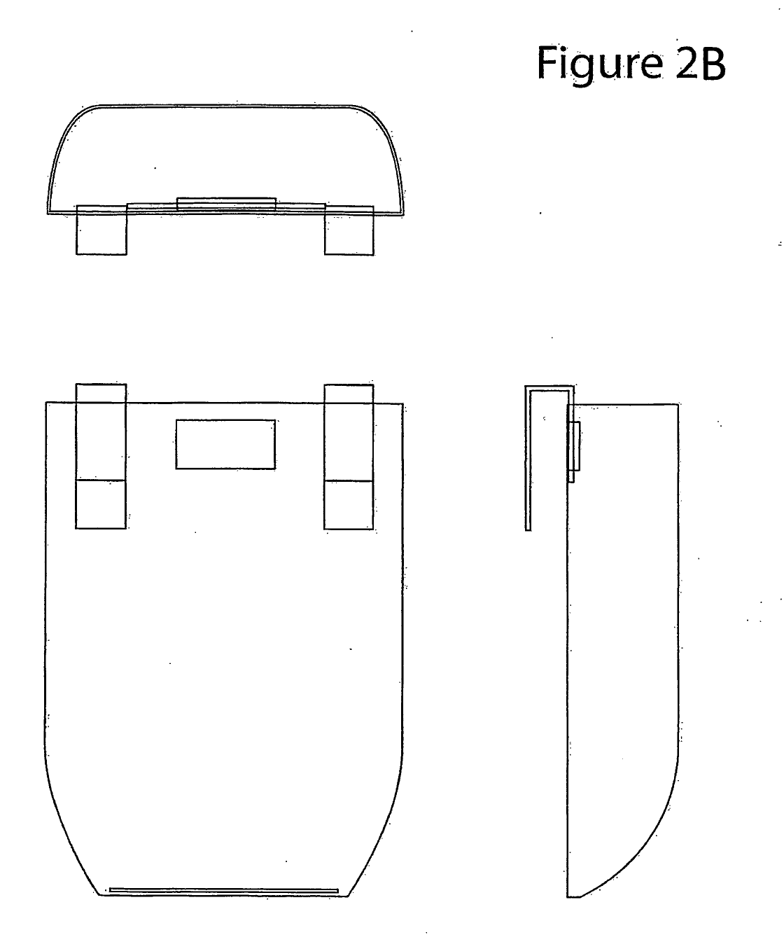

FIG. 2B Back view, Side view, Top view

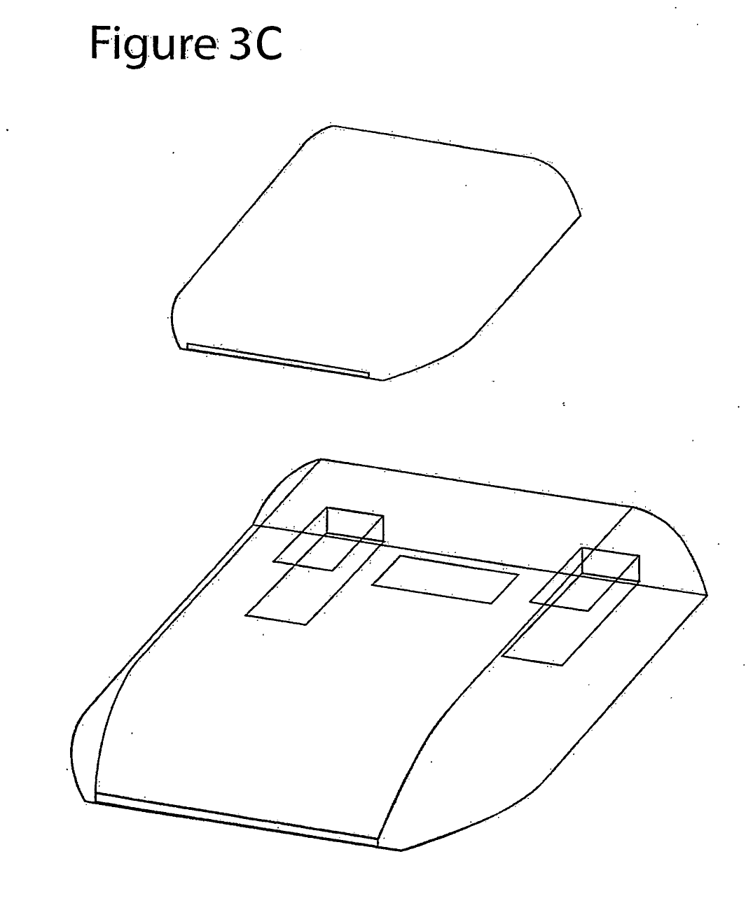

FIG. 3C Front bottom view, back bottom view

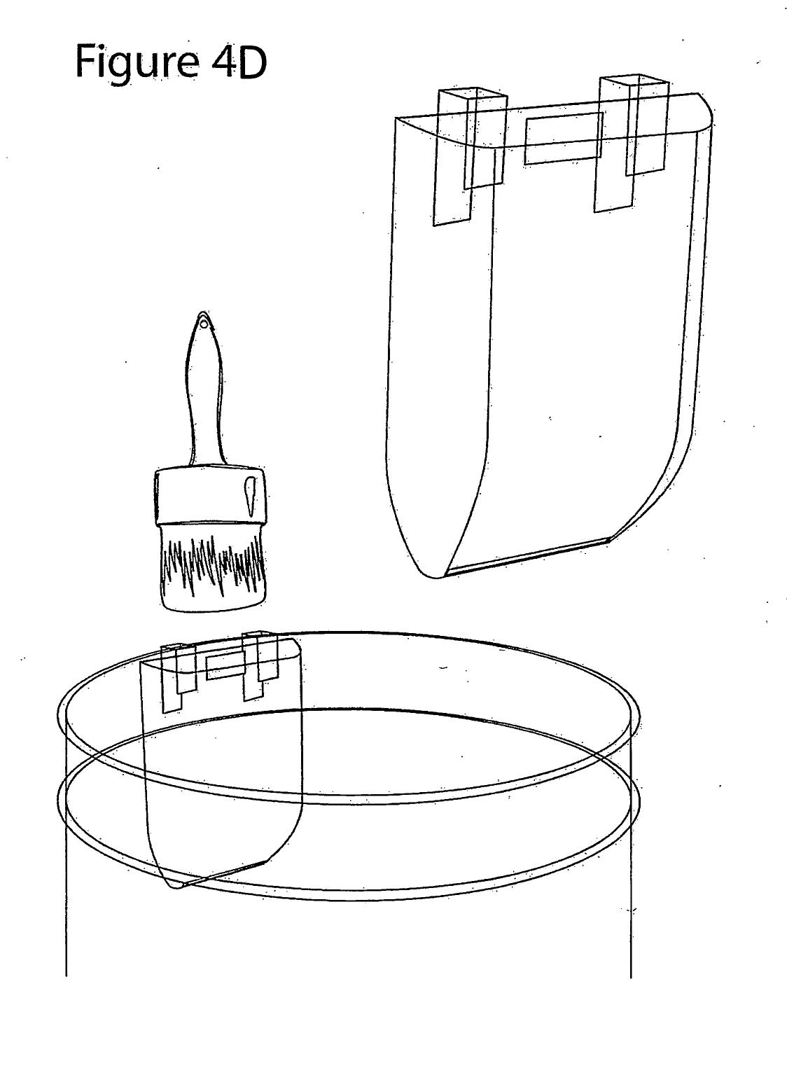

FIG. 4D whole 3D view, on paint can view

1. I claim that this paintbrush holder is Lash Lareau invention.
